(19) United States
(12) Patent Application Publication
(10) Pub. No.: US 2018/0118900 A1
(43) Pub. Date: May 3, 2018

(54) MATERIAL AND PROCESS FOR OBTAINING SAME

(71) Applicants: AVRIL, Paris (FR); Centre National de la Recherche Scientifique (CNRS), Paris cedex 16 (FR); Université Paris-Est Créteil Val de Marne (UPEC), Creteil (FR)

(72) Inventors: France Thevenieau, Chartres (FR); Carine Mangeon, Maison Alfort (FR); Estelle Renard, Bourg La Reine (FR); Valérie Langlois, Cachan (FR)

(73) Assignees: AVRIL, Paris (FR); Centre National de la Recherche Scientifique (CNRS ), Paris cedex 16 (FR); Université Paris-Est Créteil Val de Marne (UPEC), Creteil (FR)

(21) Appl. No.: 15/567,776

(22) PCT Filed: Apr. 22, 2016
(86) PCT No.: PCT/EP2016/059066

§ 371 Date: Oct. 19, 2017

(30) Foreign Application Priority Data
Apr. 24, 2015 (EP) 15305635.3

(51) Int. Cl. C08J 3/24

(52) U.S. Cl. CPC C08J 3/246; C08J 2409/00; C08J 2367/04

(57) ABSTRACT

The invention relates to a material comprising: a first crosslinked polymer forming a network, and a second linear polymer comprising n monomers, each of the monomers having the following formula I: (I), where m varies from 0 to 4, R is selected from hydrogen, an ethyl group and an alkyl group, and n is a non-zero natural integer, said material being such that it forms a semi-interpenetrating network wherein the second linear polymer is entangled in the network of the first polymer.

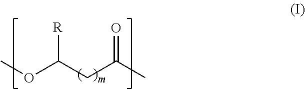

The present invention relates to a material and the process for obtaining same.

Polyhydroxyalkanoates or PHAs are biodegradable polyesters produced naturally by bacterial fermentation of carbon-based substrates (sugars, lipids, etc.). PHAs are produced by bacteria as storage materials for carbon and energy.

The polyhydroxyalkanoate family comprises more than 150 different monomers which lead to sometimes very different properties.

These polymers may thus exhibit thermoplastic or elastomeric properties with melting points ranging from 40 to 180° C.

The most well-known of the characteristics of PHAs is their biodegradability, the fact that these polymers are compostable. Designed from renewable resources, they degrade naturally within a few weeks or months once they are placed under appropriate conditions. This aspect, coupled with the fact that they bring together the majority of the properties of conventional plastics, confers a major competitive advantage upon PHAs in the plastics market.

Many physicochemical characteristics of PHAs make them high-caliber biopolymers. Their high melting point enables them to be used for applications which are inaccessible to other bioplastics. Their ability to provide a barrier to various gases, especially oxygen, is superior to most conventional polymers, thus elevating them to the rank of ideal candidates for food packaging applications. In addition, PHAs withstand several chemical products, have different possibilities for transformation (extrusion, thermoforming, etc., often with the same equipment as conventional plastics), have a high molecular weight, are resistant to moisture, can be colored, are printable, and yet more.

Although they are biodegradable, PHAs with short side chains are brittle polymers, due to a low deformation at break. Such a property is therefore not advantageous for the various industrial applications envisaged.

Thus, there is a need to overcome this drawback.

PHAs have already been used, for example, in the application DE102011012869 as plasticizers for the production of a rubber-based thermoplastic elastomer material. However, this document does not make it possible to provide a material modifying the characteristics of the PHAs.

One of the aims of the invention is to provide a biobased material of biodegradable nature, consisting essentially of PHA, which is stronger and less brittle than those known from the prior art.

Another aim of the invention is to provide a process for obtaining such a material.

Yet another aim of the invention consists in improving the polymer properties in terms of flexibility, elongation at break and thermal stability.

The invention relates to a material comprising, or essentially consisting of or consisting of:
a first crosslinked polymer forming a network, said first polymer being obtained by thiol-ene reaction between
   a first composition comprising at least one first polyunsaturated carbon-based compound comprising at least one especially linear, and in particular branched, unsaturated carbon-based chain, comprising at least 5 carbon atoms, and
   at least one second compound comprising at least two thiol or —SH functions, such that
      if the first polyunsaturated compound is bi-unsaturated, said second compound comprises at least three —SH functions, and
      if the first polyunsaturated compound is at least tri-unsaturated, said second compound comprises at least two —SH functions, and
a second polymer consisting of n monomers, each of the monomers having the following formula I:

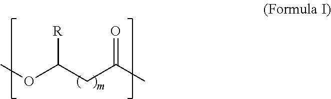

where m ranges from 0 to 4,
R is selected from hydrogen and an especially linear C1-C5 alkyl group, and
n is a non-zero natural integer greater than or equal to 100, or at least equal to 2,
the n monomers being identical or different

said material being such that it forms a semi-interpenetrating network in which the second polymer is entangled in the network of the first polymer.

The material according to the invention is characterized in that it consists of a crosslinked polymer in which a second material is entangled: it is therefore a semi-interpenetrating network.

“Semi-interpenetrating network” or “semi-IPN” is understood to mean, in the invention, a crosslinked network of a polymer in which another polymer is trapped or entangled, which other polymer is in linear form and thus in which the other polymer does not form a network. These networks are to be distinguished from interpenetrating networks or IPNs in which the two polymers are crosslinked and entangle without forming covalent bonds between them.

It should be noted that the entanglement as described above differs from the covalent bonds that might be involved in binding said polymers.

A schematic representation of the semi-IPN and IPN networks is given in FIGS. 1A and 1B.

The material according to the invention is therefore composed of two polymers: a first crosslinked polymer and a second polymer corresponding to formula I.
The Second Polymer

The second polymer is composed of a subunit or monomer:

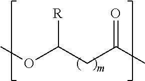

repeated n times, or of several different subunits repeated n times, said polymer possibly being a homopolymer or a heteropolymer. The term “homopolymer” is understood to mean a polymer formed exclusively of the same subunit repeated n times. The term “heteropolymer” is understood to mean a polymer comprising at least two subunits of different structures but corresponding to formula 1, which are repeated over the entire length of the polymer during the n repetitions. The second polymer may consist of one or more of the following subunits or monomers:

[O—CH₂—CO—], where m=0 and R is a hydrogen,

[O—CHCH₃—CO—], where m=0 and R is a —CH₃ group,

[O—CHC₂H₅—CO—], where m=0 and R is a —C₂H₅ group,

[O—CHC₃H₇—CO—], where m=0 and R is a —C₃H₇ group,

[O—CHC₄H₉—CO—], where m=0 and R is a —C₄H₉ group,

[O—CHC₅H₁₁—CO—], where m=0 and R is a —O₅H₁₁ group,

[O—CH₂—CH₂—CO—], where m=1 and R is a hydrogen,

[O—CHCH₃—CH₂—CO—], where m=1 and R is a —CH₃ group,

[O—CHC₂H₅—CH₂—CO—], where m=1 and R is a —C₂H₅ group,

[O—CHC₃H₇—CH₂—CO—], where m=1 and R is a —C₃H₇ group,

[O—CHC₄H₉—CH₂—CO—], where m=1 and R is a —C₄H₉ group,

[O—CHC₅H₁₁—CH₂—CO—], where m=1 and R is a —C₅H₁₁ group,

[O—CH₂—CH₂—CH₂—CO—], where m=2 and R is a hydrogen,

[O—CHCH₃—CH₂—CH₂—CO—], where m=2 and R is a —CH₃ group,

[O—CHC₂H₅—CH₂—CH₂—CO—] where m=2 and R is a —C₂H₅ group,

[O—CHC₃H₇—CH₂—CH₂—CO—], where m=2 and R is a —C₃H₇ group,

[O—CHC₄H₉—CH₂—CH₂—CO—], where m=2 and R is a —C₄H₉ group,

[O—CHC₅H₁₁—CH₂—CH₂—CO—], where m=2 and R is a —C₅H₁₁ group,

[O—CH₂—CH₂—CH₂—CH₂—CO—], where m=3 and R is a hydrogen,

[O—CHCH₃—CH₂—CH₂—CH₂—CO—], where m=3 and R is a —CH₃ group,

[O—CHC₂H₅—CH₂—CH₂—CH₂—CO—], where m=3 and R is a —C₂H₅ group,

[O—CHC₃H₇—CH₂—CH₂—CH₂—CO—], where m=3 and R is a —C₃H₇ group,

[O—CHC₄H₉—CH₂—CH₂—CH₂—CO—], where m=3 and R is a —C₄H₉ group,

[O—CHC₅H₁₁—CH₂—CH₂—CH₂—CO—], where m=3 and R is a —C₅H₁₁ group,

[O—CH₂—CH₂—CH₂—CH₂—CH₂—CO—], where m=4 and R is a hydrogen,

[O—CHCH₃—CH₂—CH₂—CH₂—CH₂—CO—], where m=4 and R is a —CH₃ group,

[O—CHC₂H₅—CH₂—CH₂—CH₂—CH₂—CO—], where m=4 and R is a —C₂H₅ group,

[O—CHC₃H₇—CH₂—CH₂—CH₂—CH₂—CO—], where m=4 and R is a —C₃H₇ group,

[O—CHC₄H₉—CH₂—CH₂—CH₂—CH₂—CO—], where m=4 and R is a —C₄H₉ group, and

[O—CHC₅H₁₁—CH₂—CH₂—CH₂—CH₂—CO—], where m=4 and R is a —C₅H₁₁ group.

For example, a [—O—CH₂—CO—] polymer is a polymer referred to as polylactic acid, a [—O—CHCH₃—CH₂—CO—] polymer is a polymer referred to as poly(3-hydroxybutyrate) or PHB or P3HB, a [—O—CHC₅H₁₁—CH₂—CO—] polymer is a polymer referred to as poly(3-hydroxyoctoate) or PHO, a [—O—CHC₂H₅—CH₂—CO—] polymer is a polymer referred to as poly(3-hydroxyvalerate) or PHV or P3HV, and a [—O—CH₂—CH₂—CH₂—CH₂—CH₂—CO—] polymer is a polymer referred to as polycaprolactone or PCL.

The copolymers ([—O—CHCH₃—CH₂—CO]; [—O—CHC₂H₅—CH₂—CO—])n are copolymers of P3HB and P3HV, referred to as P3HBHV. In the context of such polymers it is possible to determine the amount of each subunit and to give the proportion thereof. These proportions are evaluated by proton NMR (nuclear magnetic resonance). The composition is determined from the integrations of the protons at 5.15-5.25 ppm and the integration of the terminal methyl group of the PHB unit at 0.9 ppm according to the following equation:

$$\% 3 HV = \frac{I 0.9 ppm / 3 }{I 5.15 - 5.25} * 100$$

Thus, when the proportion of each of the subunits is known, it is possible to write the proportions in the name of the polymer. By way of example, P3HB88HV12 means that the polymer (PH3B3HV) comprises 88% P3HB units and 12% P3HV units.

The second polymers which are also polyhydroxyalkanoates or PHAs can also be classified according to the size or the length of the side chain R. Thus, PHAs in which R is H, —CH₃ or —C₂H₅, regardless of m, are PHAs with short side chains, referred to as PHA-scl (for short chain length-PHA). PHAs in which R is —C₃H₇, —C₄H₈ or —C₅H₁₁, regardless of m, are PHAs with medium side chains, referred to as PHA-mcl (for medium chain length-PHA).

When the length of the side chain R increases, the PHAs are rather ductile or malleable.

The repeating unit, represented by the formula I, is repeated n times, where n is a natural integer greater than 100. This means that the second polymer has at least 100 subunits, especially 100, or 200, or 300, or 400, or 500, or 600, or 700, or 800, or 900, or 1000, or 2000, or 3000, or 4000, or 5000 or 6000, or 7000, or 8000, or 9000 or 10 000 subunits or more.

In the invention, it is advantageous for the second polymer to have a mass of 9000 g/mol or more. This means that the second polymer has a molar mass of 9000, 10 000, 11 000, 12 000, 13 000, 14 000, 15 000, 16 000, 17 000, 18 000, 19 000, 20 000, 30 000, 40 000, 50 000, 60 000, 70 000, 80 000, 90 000 g/mol or more.
The First Polymer

The first polymer is a crosslinked polymer, which forms a network or net. The network is a three-dimensional network which is obtained by thiol-ene reaction.

In this case, in the first step, a radical is formed on the sulfur using a radical initiator (init). It is this sulfur-based radical which will then be added on to the double bond.

The reaction can be diagrammatically represented as follows:

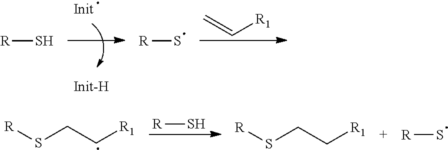

This reaction therefore requires:
a sulfur-based compound having at least one thiol —SH function, and
a compound comprising at least one unsaturation, that is to say at least one C═C double bond.

Within the context of the invention, the first polymer which is in the form of a network after crosslinking is composed of:
a first polyunsaturated carbon-based compound comprising at least one especially linear, and in particular branched, unsaturated carbon-based chain, comprising at least 5 carbon atoms, and
at least one second compound comprising at least two thiol or —SH functions.

The term “polyunsaturated carbon-based compound comprising at least one unsaturated carbon-based chain” is understood to mean, in the invention, a chemical compound having at least two unsaturations, that is to say at least two C═C double bonds.

The carbon-based compound, which essentially comprises carbon and hydrogen atoms, but which may comprise O, N, or halogen atoms, etc., comprises at least one unsaturated carbon-based chain.

This means that the compound may be linear (it therefore comprises one carbon chain), but also cyclic. If it is cyclic, it preferably comprises at least one unsaturated linear radical or portion.

Advantageously, at least one of the C═C unsaturations is present on said at least one carbon-based linear chain.

Compounds corresponding to this definition are polyunsaturated hydrocarbons having at least 5 carbon atoms, polyunsaturated carboxylic acids having at least 5 carbon atoms, polyunsaturated fatty acids, or any hydrocarbon having at least 5 carbon atoms and which may have one or more ether, alcohol, acid, amine, amide, ketone, or other functions. In addition, the compounds may be carboxylic acid ethers, such as polyunsaturated monoacylglycerols, diacylglycerols or triacylglycerols.

Advantageous compounds are polyisoprene or polyunsaturated fatty acids, especially C10-C25 polyunsaturated fatty acids, or the corresponding monoacyl, diacyl or triacylglycerols.

The C10-C25 polyunsaturated fatty acids are fatty acids comprising a carbon-based chain comprising 10 carbon atoms, 11 carbon atoms, 12 carbon atoms, 13 carbon atoms, 14 carbon atoms, 15 carbon atoms, 16 carbon atoms, 17 carbon atoms, 18 carbon atoms, 19 carbon atoms, 20 carbon atoms, 21 carbon atoms, 22 carbon atoms, 23 carbon atoms, 24 carbon atoms or 25 carbon atoms.

In the particular case of diacylglycerols or triacylglycerols, which have, respectively, two or three fatty acids, the first compound according to the invention will be said to be polyunsaturated if at least two of the fatty acids have a C═C unsaturation, or if one of the fatty acids has at least two unsaturations, the other fatty acid(s) not having any C═C unsaturations. Of course, if one, two or, where appropriate, three of the fatty acids are at least monounsaturated, the first compound will be said to be polyunsaturated.

In order to obtain a first crosslinked polymer forming a network, it is important that
if the first polyunsaturated compound is bi-unsaturated, said second compound comprises at least three —SH functions, and
if the first polyunsaturated compound is at least tri-unsaturated, said second compound comprises at least two —SH functions.

It is advantageous in the invention that the proportion of the first polyunsaturated carbon-based compound represents 40% or less by weight relative to the weight of the second polymer.

More advantageously, the first polyunsaturated carbon-based compound represents from 4% to 40% by weight relative to the weight of the second polymer, especially from 10% to 30% by weight relative to the weight of the second polymer, more particularly from 10% to 20% by weight relative to the weight of the second polymer.

In the invention, “from 4% to 40% by weight” means that the first polyunsaturated carbon-based compound may represent, relative to the weight of the second polymer, approximately 4%, approximately 5%, approximately 6%, approximately 7%, approximately 8%, approximately 9%, approximately 10%, approximately 11%, approximately 12%, approximately 13%, approximately 14%, approximately 15%, approximately 16%, approximately 17%, approximately 18%, approximately 19%, approximately 20%, approximately 21%, approximately 22%, approximately 23%, approximately 24%, approximately 25%, approximately 26%, approximately 27%, approximately 28%, approximately 29%, approximately 30%, approximately 31%, approximately 32%, approximately 33%, approximately 34%, approximately 35%, approximately 36%, approximately 37%, approximately 38%, approximately 39% approximately 40%. “Approximately” in the above percentage ranges is understood to mean a variation of plus or minus 10%, that is to say “approximately 10%” is interpreted as covering values from 9.9% to 10.1%.

The material according to the invention is preferentially obtained from PHA-scl which has thermoplastic properties. However, the process outlined below may be applicable to PHAs with medium side chains, or PHA-mcls, such as PHO. However, given its elastic properties, the results will not be as advantageous.

In order to determine whether the material obtained does indeed form a semi-interpenetrating network, the following techniques are of use. Scanning electron microscopy (SEM) techniques reveal information on the size, shape and continuity of the domains, but these studies do not make it possible to know the composition of the contributors in the different phases.

Differential scanning calorimetry (DSC) and dynamic mechanical analysis (DMA) can provide information on the composition of each phase and the degree of interpenetration thereof, through shifts and widening of the glass transition temperatures (Tg) of the polymers involved. If the two Tgs are separate, the polymers are considered to be immiscible. This is reflected in a phase macroseparation with ranges of between 500 nm to 3 μm for the semi-IPNs. When a single Tg is observed (intermediate between those of the precursors) the polymers are miscible and phase separation is restricted in these systems.

Turbidity may also be considered as a parameter which makes it possible to evaluate the degree of interpenetration of the chains and the size of the micro-domains, provided that the refractive indices of the two partners are sufficiently different.

Advantageously, the invention relates to an abovementioned material, wherein said first compound is an at least bi-unsaturated triglyceride, or a polyisoprene, essential fatty acids, or terpenes, especially carotene, farnesene, lycopene, phytoene, linalool or geraniol.

The various abovementioned compounds are all polyunsaturated and comprise a carbon-based chain of at least 5 carbon atoms.

“An at least bi-unsaturated triglyceride” is understood to mean, in the invention, a triglyceride, at least one of the fatty acids of which comprises at least two unsaturations or at least two of the fatty acids of which comprise at least one unsaturation.

“Essential fatty acids” is understood to mean, in the invention, especially linoleic acid, α-linolenic acid, arachidonic acid, eicosapentaenoic acid, docosahexaenoic acid.

Advantageously, the first compound is included in a composition comprising one or more at least bi-unsaturated triglycerides.

Thus, in one advantageous embodiment, the invention relates to an abovementioned material, comprising, or essentially consisting, or consisting, of
a first crosslinked polymer forming a network, said first polymer being obtained by thiol-ene reaction between
   a composition comprising one or more at least bi-unsaturated, especially linear, and in particular branched, triglycerides, comprising at least 5 carbon atoms, and
   at least one second compound comprising at least two thiol or —SH functions, such that
      if the first polyunsaturated compound is bi-unsaturated, said second compound comprises at least three —SH functions, and
      if the first polyunsaturated compound is at least tri-unsaturated, said second compound comprises at least two —SH functions,
and
a second polymer consisting of n monomers, each of the monomers having the following formula I:

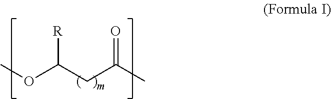

where m ranges from 0 to 4.
R is selected from hydrogen and an especially linear C1-C5 alkyl group, and
n is a non-zero natural integer greater than or equal to 100, or at least equal to 2,
the n monomers being identical or different

said monomers being selected from the following monomers: [O—CH₂—CO—], [O—CHCH₃—CO—], [O—CHC₂H₅—CO—][O—CHC₃H₇—CO—], [O—CHC₄H₉—CO], [O—CHC₅H₁₁—CO—], [O—CH₂—CH₂—CO—], [O—CHCH₃—CH₂—CO—], [O—CHC₂H₅—CH₂—CO—], [O—CHC₃H₇—CH₂—CO—], [O—CHC₄H₉—CH₂—CO—], [O—CHC₅H₁₁—CH₂—CO—], [O—CH₂—CH₂—CH₂—CO], [O—CHCH₃—CH₂—CH₂—CO—], [O—CHC₂H₅—CH₂—CH₂—CO—], [O—CHC₃H₇—CH₂—CH₂—CO], [O—CHC₄H₉—CH₂—CH₂—CO—], [O—CHC₅H₁₁—CH₂—CH₂—CO—], [O—CH₂—CH₂—CH₂—CH₂—CO—], [O—CHCH₃—CH₂—CH₂—CH₂—CO—], [O—CHC₂H₅—CH₂—CH₂—CH₂—CO—], [O—CHC₃H₇—CH₂—CH₂—CH₂—CO—], [O—CHC₄H₉—CH₂—CH₂—CH₂—CO—], [O—CHC₅H₁₁—CH₂—CH₂—CH₂—CO—], [O—CH₂—CH₂—CH₂—CH₂—C H₂—CO—], [O—CHCH₃—CH₂—CH₂—CH₂—CH₂—CO—], [O—CHC₂H₅—CH₂—CH₂—CH₂—CH₂—CO—], [O—CHC₃H₇—CH₂—CH₂—CH₂—CH₂—CO—], [O—CHC₄H₉—CH₂—CH₂—CH₂—CH₂—CO—] or [O—CHC₅H₁₁—CH₂—CH₂—CO—CH₂—CH₂],

said material being such that it forms a semi-interpenetrating network in which the second polymer is entangled in the network of the first polymer.

“Entangled” is understood to mean, in the invention, that the first polymer and the second polymer are mixed up with one another in a disordered manner.

Advantageously, the invention relates to the abovementioned material in which the proportion of the first polyunsaturated carbon-based compound represents 40% or less by weight relative to the weight of the second polymer.

More advantageously, the first polyunsaturated carbon-based compound represents from 4% to 40% by weight relative to the weight of the second polymer, especially from 10% to 30% by weight relative to the weight of the second polymer, more particularly from 10% to 20% by weight relative to the weight of the second polymer.

Advantageously, the invention relates to an abovementioned material, wherein said first composition comprises at least one first polyunsaturated carbon-based compound comprising at least one unsaturated carbon-based chain is a composition comprising or consisting of one or more oils selected from vegetable oils, fish oils, and microbial oils resulting from microorganisms referred to as oleaginous, especially a vegetable oil such as rapeseed oil, oleic rapeseed oil, sunflower oil, oleic sunflower oil, coconut oil, palm oil, palm kernel oil, olive oil, peanut oil, soybean oil, corn oil, mustard oil, castor oil, palm olein, palm stearin, safflower oil, sesame oil, linseed oil, walnut oil, grapeseed oil, hemp oil or a by-product derived from the extraction thereof comprising at least 30% of a mixture of fatty acids, such as esterification waters, tank bottoms, deodorizing condensates, washing waters or neutralizing pastes,
fish oils, especially of fatty fish, and
microbial oils derived from microorganisms referred to as oleaginous, that is to say capable of storing fatty acids at more than 20% of their dry weight, derived from yeasts, bacteria, fungi or microalgae.

These examples of oil are given by way of indication and in no way limit the scope of the invention.

In the invention, the term “vegetable oil” is understood to mean a fatty substance extracted from an oleaginous plant.

Oleaginous plants are understood to mean all plants, the seeds, nuts or fruits of which contain lipids.

A fatty substance is a substance composed of molecules having hydrophobic properties. The fatty substances are predominantly composed of fatty acids and triglycerides which are esters consisting of a molecule of glycerol and three fatty acids. The other components form what is referred to as the unsaponifiable.

The extraction of vegetable oil by traditional methods often requires various preliminary operations, such as hulling. After these operations, the culture is ground into a paste. The paste, or sometimes the whole fruit, is boiled in the presence of water and with stirring until the oil separates. These traditional methods have a low efficiency.

Modern methods of oil recovery comprise steps of breaking and pressing, and also dissolution in a solvent, commonly hexane. Extracting the oil with a solvent is a more efficient method than pressing. The residue left after extraction of the oil (cake or flour) is used as animal feed.

Crude vegetable oils are obtained without additional treatment other than degumming or filtration. To make them fit for human consumption, edible vegetable oils are refined to eliminate impurities and toxic substances, a process involving bleaching, deodorization and cooling. The vegetable oils envisaged in the invention comprise crude, refined or fractionated oils or co-products resulting from the extraction of oils.

With a few exceptions, and unlike animal fats, vegetable oils contain predominantly unsaturated fatty acids of two kinds: monounsaturated (such as palmitic acid, oleic acid or erucic acid) and polyunsaturated (such as linoleic acid).

In another advantageous embodiment, the invention relates to an abovementioned material, in which the second polymer is a polyhydroxyalkanoate polymer with short side chains, or PHA-scl, consisting of n monomers of formula I, where m ranges from 1 to 3,

R is selected from hydrogen, an ethyl group and a methyl group, and

n is a non-zero natural integer greater than or equal to 100,

said PHA-scls being especially poly-3-hydroxybutyrates or PHBs and/or poly(3-hydroxybutyrate-co-3-hydroxyvalerate)s or PHBHVs.

These materials are particularly advantageous insofar as they have good elastic properties as detailed in the examples below.

In another advantageous embodiment, the invention relates to an abovementioned material, in which the compound comprising at least two —SH functions is selected from the following compounds:

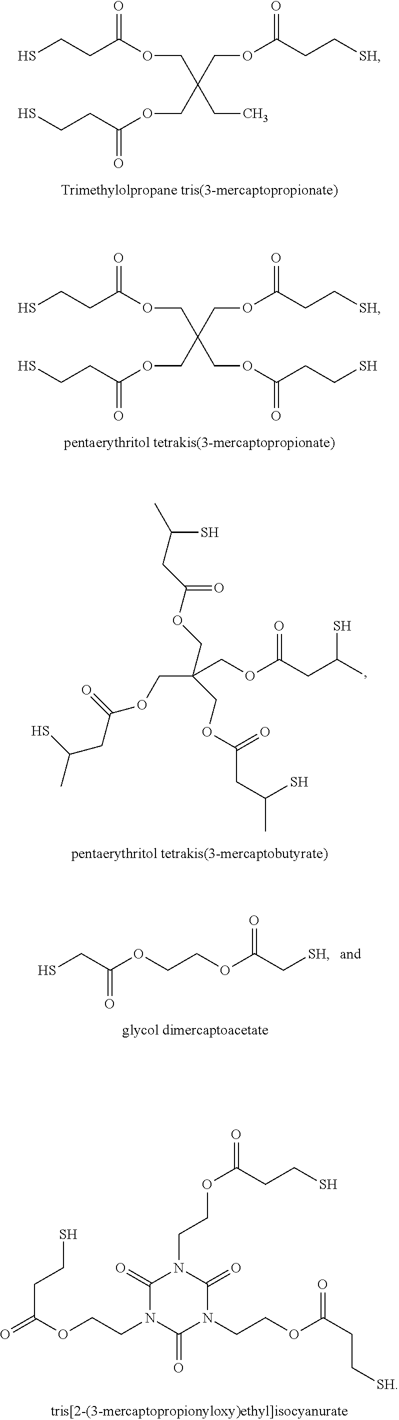

The more the second compound comprises thiol functions, the more the network will be crosslinked, that is to say the more numerous the meshes will be. Similarly, the more the thiol functions are spaced apart on the backbone of the second compound, the wider the mesh will be.

Other polythiols known to those skilled in the art are, of course, of use in the context of the invention.

In another advantageous embodiment, the invention relates to an abovementioned material, wherein the first compound, or the composition comprising said first compound, represents from 4 to 20% by weight of the total weight of the material.

The inventors have been able to show that, in order to impart elastic or plastic properties to the PHAs, it was sufficient to add from 4 to 20% of the abovementioned polyunsaturated compound. Crosslinking in the presence of the second compound having thiol functions will then be possible and the final material will therefore have approximately 4% to approximately 20% by weight of polyunsaturated compound relative to the total weight of the material.

The invention also relates to a process for preparing a material, especially as defined above,

said process comprising

a) the mixing:
of a first composition comprising at least one first polyunsaturated carbon-based compound comprising at least one unsaturated carbon-based chain, with
at least one compound comprising at least two —SH functions,
at least one radical initiator,
and at least one polymer consisting of n monomers, each of the monomers having the following formula I:

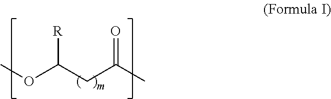

where m ranges from 0 to 4,

R is selected from hydrogen, an ethyl group and an especially linear C1-C5 alkyl group, and

n is a non-zero natural integer greater than or equal to 100, or at least equal to 2,

the n monomers being identical or different

to obtain an initial composition,

and

b) a step of crosslinking the first polymer between said at least one polyunsaturated carbon-based comprising at least one unsaturated carbon-based chain and the compound comprising at least two —SH functions.

Advantageously, the invention relates to a process for preparing a material as defined above,

said method comprising

c) the mixing:
of a first composition comprising at least one first polyunsaturated carbon-based compound comprising at least one unsaturated carbon-based chain, with
at least one compound comprising at least two —SH functions,
at least one radical initiator,
and at least one polymer consisting of n monomers, each of the monomers having the following formula I:

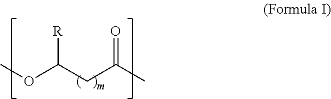

where m ranges from 0 to 4,

R is selected from hydrogen, an ethyl group and an especially linear C1-C5 alkyl group, and

n is a non-natural integer at least equal to 2,

the n monomers being identical or different

to obtain an initial composition,

and

d) a step of crosslinking the first polymer between said at least one polyunsaturated carbon-based compound comprising at least one unsaturated carbon-based chain and the compound comprising at least two —SH functions,

the amount of said first polyunsaturated carbon-based compound representing 40% or less by weight relative to the weight of said polymer consisting of n monomers of formula I, especially from 4% to 30%, in particular from 10 to 20% by weight relative to the weight of said polymer consisting of n monomers of formula I.

The process according to the invention is simple, quick and very efficient in terms of yield. Indeed, the inventors have shown that simply bringing the various components of the first polymer into contact in the presence of the second polymer with a radical initiator enabling crosslinking of the first polymer, the result being that the second polymer becomes entangled in the network of the first polymer. The material thus obtained is a semi-interpenetrating network.

The crosslinking reaction of the first polymer is initiated by a radical initiator. A radical initiator is a species capable of forming radicals. These substances generally have weak chemical bonds, that is to say bonds which have a low homolytic dissociation energy by photolysis or thermolysis, for example.

The reaction is carried out at room temperature, that is to say in a temperature range extending especially from approximately 16° C. to approximately 28° C., especially from approximately 19° C. to approximately 22° C.

The initiators according to the invention are especially photochemical initiators capable of generating radicals under the action of light rays, especially ultraviolet (UV) radiation.

The radical initiator may also be a redox initiator for which the production of radicals results from an oxidation-reduction reaction: aqueous hydrogen peroxide/ferrous ion system.

The radical initiator may also be thermal, such as azo initiators (e.g.: 2,2′-azobisisobutyronitrile), organic peroxides (e.g. tert-butyl peroxide, cumyl hydroperoxide). The radicals are released by thermal decomposition.

In the first step, a radical is formed on the sulfur using a radical initiator (init). It is this sulfur-based radical which will then be added on to the double bond.

The reaction can be diagrammatically represented as follows:

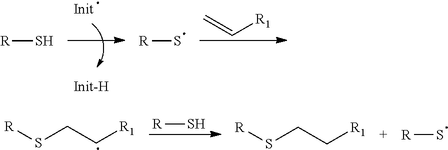

In the process according to the invention, if the first and second polymers are in the liquid state, it is sufficient to mix them. On the other hand, when one or both polymers are in the solid state, or one of them is in the solid state and the other is in the liquid state, it may be necessary to carry out an extrusion in order to mix them. It will be noted that, in the case of an extrusion, it is not advantageous to use a heat-activatable radical initiator, since there is a risk that the polymerization of the first polymer will start during extrusion.

An alternative is dissolving the solid polymer(s) in a suitable solvent in order to obtain a homogeneous mixture of the two polymers in which the two polymers can mix together. In this case it will be necessary, before initiation of the thiol-ene reaction, to eliminate the solvent, for example by evaporation. Solvents which are of use, without being limiting, are dichloromethane, chloroform or tetrahydrofuran.

In certain advantageous embodiments, the first composition serves as solvent for said polymer consisting of n monomers. It will therefore not be necessary to add a solvent to the reaction.

Also advantageously, the invention relates to a process as defined above in which, in step a), a suitable solvent is added and in which, after step a), the solvent is eliminated before step b).

In other words, the invention advantageously relates to a process for preparing a material, especially as defined above, said process comprising
a) the mixing:
   a. of a first composition comprising at least one first polyunsaturated carbon-based compound comprising at least one unsaturated carbon-based chain, with
   b. at least one compound comprising at least two —SH functions,
   c. optionally at least one solvent,
   d. at least one radical initiator,
   e. and at least one polymer consisting of n monomers, each of the monomers having the following formula I:

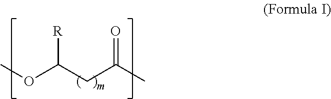

where m ranges from 0 to 4,

R is selected from hydrogen, an ethyl group and an especially linear C1-C5 alkyl group, and

n is a non-zero natural integer greater than or equal to 100,

the n monomers being identical or different,

to obtain an initial composition,

b) a step of eliminating said solvent from the initial composition, and

c) a step of crosslinking the first polymer between said at least one polyunsaturated carbon-based comprising at least one unsaturated carbon-based chain and the compound comprising at least two —SH functions.

The invention advantageously relates to a process for preparing a material, especially as defined above,

said process comprising

a) the mixing:
a. of a first composition comprising at least one first polyunsaturated carbon-based compound comprising at least one unsaturated carbon-based chain, with
b. at least one compound comprising at least two —SH functions,
c. optionally at least one solvent,
d. and at least one polymer consisting of n monomers, each of the monomers having the following formula I:

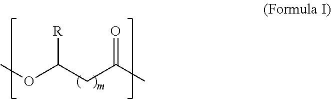

where m ranges from 0 to 4,

R is selected from hydrogen, an ethyl group and an especially linear C1-C5 alkyl group, and

n is a non-zero natural integer greater than or equal to 100,

the n monomers being identical or different,

to obtain an initial composition,

b) a step of extruding the initial composition, and

c) a step of crosslinking the first polymer between said at least one polyunsaturated carbon-based comprising at least one unsaturated carbon-based chain and the compound comprising at least two —SH functions.

Advantageously, the invention relates to a material comprising, or essentially consisting of or consisting of:
a first crosslinked polymer forming a network, said first polymer being obtained by thiol-ene reaction between
   a first composition comprising at least one first polyunsaturated carbon-based compound comprising at least one especially linear, and in particular branched, unsaturated carbon-based chain, comprising at least 5 carbon atoms, and
   at least one second compound comprising at least two thiol or —SH functions, such that
      if the first polyunsaturated compound is bi-unsaturated, said second compound comprises at least three —SH functions, and
      if the first polyunsaturated compound is at least tri-unsaturated, said second compound comprises at least two —SH functions, and
a second polymer consisting of n monomers, each of the monomers having the following formula I:

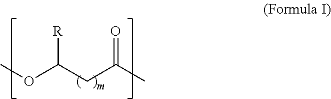

where m ranges from 0 to 4,
R is selected from hydrogen and an especially linear C1-C5 alkyl group, and
n is a non-zero natural integer greater than or equal to 100, or at least equal to 2,

said material being such that it forms a semi-interpenetrating network where the second polymer is entangled in the network of the first polymer,

said process being as described above.

In one advantageous embodiment, the invention relates to an abovementioned process, in which the radical initiator is a photochemical radical initiator, especially selected from:

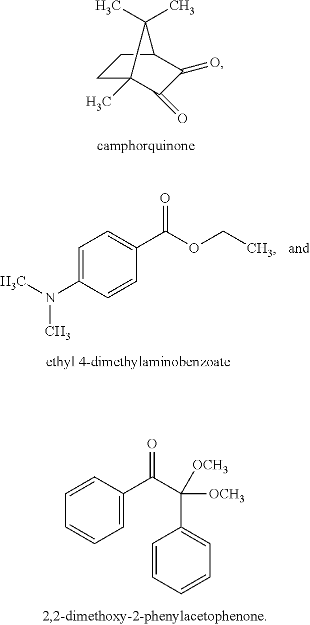 [SMILES: CC12CCC(C(=O)C1=O)C2(C)C ; CCOC(=O)c1ccc(N(C)C)cc1 ; "and" ; COC(OC)(C(=O)c1ccccc1)c1ccccc1]

In one advantageous embodiment, the invention relates to an abovementioned process, wherein said composition comprising at least one first polyunsaturated carbon-based compound comprising at least one unsaturated carbon-based chain is a composition comprising or consisting of one or more oils selected from vegetable oils, fish oils, and microbial oils resulting from microorganisms referred to as oleaginous, especially a vegetable oil such as rapeseed oil, oleic rapeseed oil, sunflower oil, especially a rapeseed oil and/or a sunflower oil. The various abovementioned oils are also of use.

Advantageously, the invention relates to an abovementioned process, wherein the first composition comprising said first compound represents from 4 to 20% by weight relative to the total weight of the initial composition.

Advantageously, the invention relates to an abovementioned process, wherein the second polymer is a polyhydroxyalkanoate polymer with short side chains, or PHA-scl, of formula I, where m ranges from 1 to 3,

R is selected from hydrogen, an ethyl group and a methyl group, and

n is a non-zero natural integer greater than or equal to 100,

said PHA-scls being especially poly-3-hydroxybutyrates or PHBs and/or poly(3-hydroxybutyrate-co-3-hydroxyvalerate)s or PHBHVs.

In a yet more advantageous embodiment, the invention relates to an abovementioned process, wherein step a) consists of, for 15 to 30 minutes, especially for approximately 20 to 25 minutes, in a suitable receptacle, bringing a composition comprising rapeseed oil and/or sunflower oil into contact with
Trimethylolpropane tris(3-mercaptopropionate),
poly(3-hydroxybutyrate) and/or poly(3-hydroxybutyrate-co-3-hydroxyvalerate),

and
2,2-dimethoxy-2-phenylacetophenone,
a solvent, especially dichloromethane,

to form the initial composition.

Furthermore, in step b), the radical initiator is advantageously a photochemical radical initiator which is activatable by UV radiation.

Advantageously, in the abovementioned process, in step b), the UV radiation emitted by a Hamamatsu LC8 lamp (L8251), at a wavelength of 250 to 450 nm. The UV radiation is advantageously applied to the initial composition with an intensity at the surface of the sample equal to approximately 9 mW.cm² for approximately 200 to approximately 500 seconds.

This radical activation is short, which makes the process very advantageous. Once activated, the polymerization reaction of the first polymer will propagate and form a crosslinked network in which the second polymer will be interpenetrated.

The invention also relates to a material able to be obtained by the foregoing as defined above.

Advantageously, the abovementioned material is able to be obtained by mixing a first polymer obtained by polymerization or crosslinking according to the thiol-ene reaction between one or more oils comprising one or more polyunsaturated fatty acids such as linolenic acid, linoleic acid, or else arachidonic acid, calendic acid, oleostearic acid, eicosapentaenoic acid, docosahexaenoic acid or several monounsaturated fatty acids such as ricinoleic acid, palmitoleic acid, oleic acid, nervonic acid, erucic acid, or a mixture thereof. Advantageously, said monounsaturated or polyunsaturated fatty acids are in the form of monoacylglycerol, diacylglycerol or triacylglycerol.

The nature and composition of the oil or mixture of oils used will confer different crosslinking properties on the first polymer.

In the invention, following the implementation of the abovementioned process, the inventors were able to obtain materials in the form of films with a mean thickness of approximately 200 μm. The thickness of the material will depend on the amount of material introduced.

The invention also relates to the use of a material as defined above for the preparation of biodegradable and/or compostable food containers, packaging, coatings, especially surface coatings, for the preparation of injected parts or parts manufactured by extrusion or for the preparation of surface coatings, especially for the manufacture of interior coatings for vehicles or else for the preparation of textiles or ropes. The material according to the invention may be used for the manufacture of:
packaging used in the food industry, such as the preparation of stretchable and retractable films for shrink wrapping and palletizing (including shrink films and covers), sacks and bags, boxes, flexible containers, tubes, flasks, stoppers, tubs, stoppers which are screwed or snap-fastened or with hinges and stopper seals, tubs, spacers, trays, reusable crates and compartment-containing trays, disposable tableware, alveoli, sheets for thermoforming, transparent bags and films, wrappers, bottles, reheating plates, pots, buckets, reusable packaging, bottles, baby bottles, drinking straws and make-up containers,
industrial products, cable-making products, for preparing geomembranes, sealing films and also in the form of pipes or tubes or for the manufacture of masterbatches,
extrusion coating on paper, cardboard or aluminum foil
used in agriculture to manufacture mulch, greenhouses, silage or tunnels,
in industry for an extrusion blow-molding process used for the manufacture of very large series of various objects. The material as defined above may be used in toys, for the packaging of liquid or solid pharmaceutical or hygiene products, surfactant or non-surfactant liquid detergents, liquid or pasty cosmetic products, and as a mixture for pasteurized milk bottles,
as floor coverings, or as ceiling coverings of the stretched ceiling type,
in the field of automotive construction, especially for the manufacture of bumpers, dashboards, passenger compartment trim and tanks for petrol and brake fluid,
in the textile industry, for the manufacture of furnishing fabrics, disposable professional garments (painting overalls, bouffant caps, surgical masks, etc.), high strength woven bags and geotextiles. The material may also be used as a supplement in synthetic ropes and carpets or as an adjuvant in concrete mixes to increase the surface properties of the concrete.

The invention also relates to a material as defined above for the use thereof in human or animal surgery.

In the medical field, the material according to the invention may be a resorbable material such as suture materials, implants, or as a material for the encapsulation of medicinal or non-medicinal active substances.

In the medical field, the material according to the invention may be used to manufacture resorbable materials for suture materials, implants, or for the encapsulation of active substances.

The invention also relates to the use of the material as defined in the context of the manufacture of equipment and materials for medical use, for humans or animals.

The invention will be better understood in light of the following figures and examples:

### FIGURE LEGEND

FIGS. 1A and 1B diagrammatically show the interpenetrating (FIG. 1A) and semi-interpenetrating networks (FIG. 1B).

FIG. 2 diagrammatically shows the structure of a semi-IPN PHA/oil/trithiol network. A shows a triglyceride of the oil, B shows a trithiol and C shows a linear PHA chain.

FIG. 3 shows the tensile curves obtained on different samples: A: of PHBHV alone, B: of PHBHV+10% oil, C: of PHBHV+20% oil, D: of PHBHV+30% oil and E: of PHBHV+40% oil. The abscissa axis shows the deformation in % and the ordinate axis shows the stress in MPa.

FIG. 4 shows the tensile curves obtained on different samples: A: of PHB alone, B: of PHB+10% oil without crosslinking, C: of PHB+20% crosslinked oil, and D: of PHB+20% crosslinked oil. The abscissa axis shows the deformation in % and the ordinate axis shows the stress in MPa.

FIG. 5 shows the tensile curves obtained on different samples: A: of PCL alone, B: of PCL+10% crosslinked oil, C: of PCL+20% crosslinked oil, D: of PCL+10% non-crosslinked oil, and E: of PCL+20% non-crosslinked oil. The abscissa axis shows the deformation in % and the ordinate axis shows the stress in MPa.

FIG. 6 shows the tensile curves obtained on different samples: A: of PLA alone, B: of PLA+10% crosslinked oil, and C: of PLA+20% crosslinked oil. The abscissa axis shows the deformation in % and the ordinate axis shows the stress in MPa.

FIG. 7 shows the curves of a thermogravimetric analysis (TGA) for different products: A: sunflower oil, B: crosslinked sunflower oil, C: PHB network+sunflower oil, and D: PHB alone. The abscissa axis shows the temperature in ° C. and the ordinate axis shows the mass loss in %.

FIG. 8 shows the tensile curves obtained on different samples: A: of PHBHV alone, B: of PHBHV+10% crosslinked polyisoprene, C: of PHBHV+20% crosslinked polyisoprene, D: of PHBHV+30% crosslinked polyisoprene and E: of PHBHV+40% crosslinked polyisoprene. The abscissa axis shows the deformation in % and the ordinate axis shows the stress in MPa.

FIGS. 9A and 9B represent a comparison of films obtained with PHB.

FIG. 9A shows a photograph of a film obtained from 100% PHB under a heating press.

FIG. 9B shows a photograph of a semi-IPN network PHB/linalool/trithiol obtained by heating press.

FIG. 10 shows the tensile curves obtained on different samples: A: from non-irradiated irradiated PHB/linalool and B: from irradiated PHB/linalool. The abscissa axis shows the deformation in % and the ordinate axis shows the stress in MPa.

FIG. 11 shows the tensile curves obtained on different samples: A: of PHBHV alone and B: of PHBHV/unsaturated lignin, trithiol. The abscissa axis shows the deformation in % and the ordinate axis shows the stress in MPa.

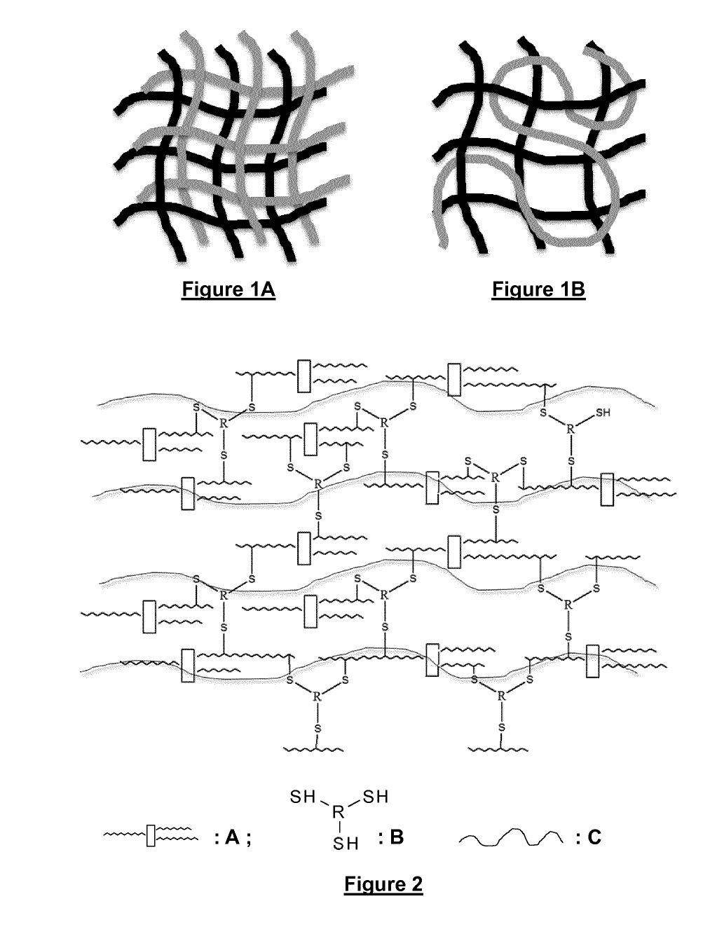

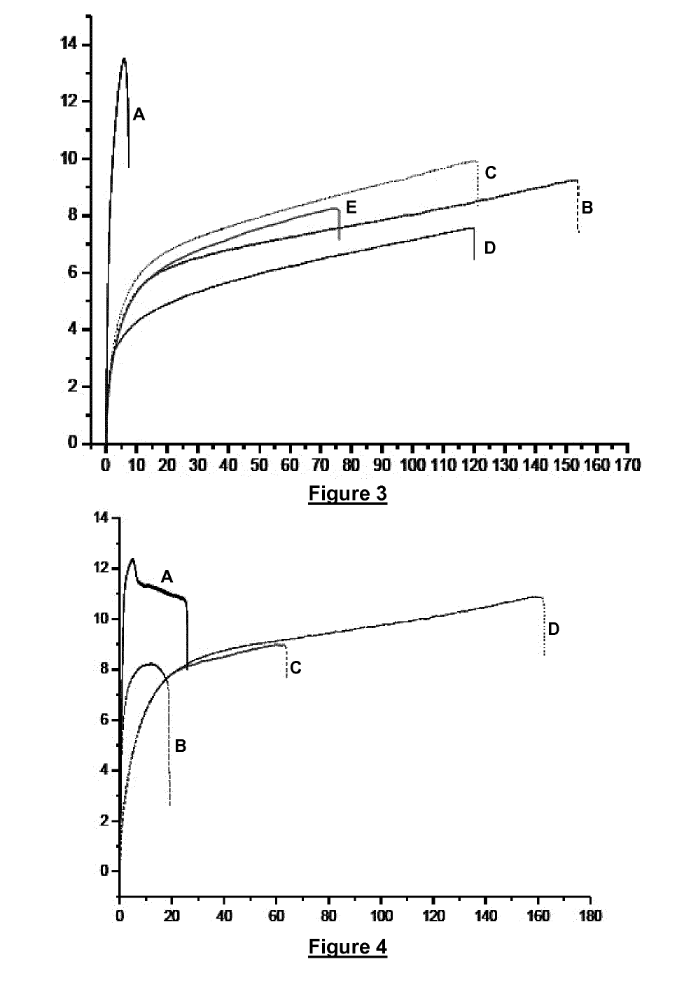

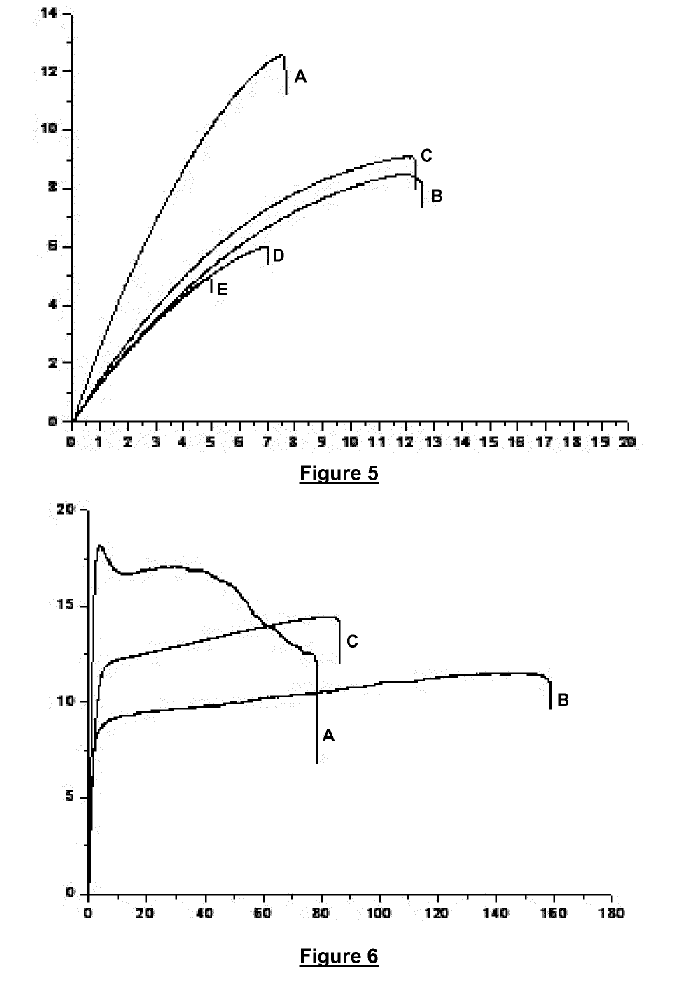

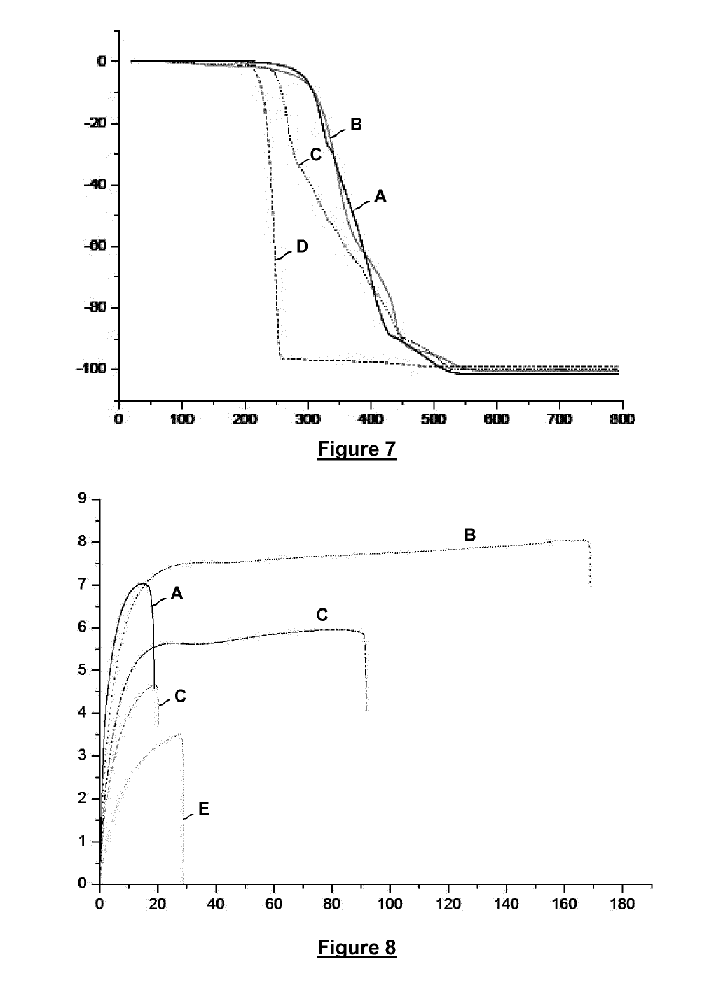

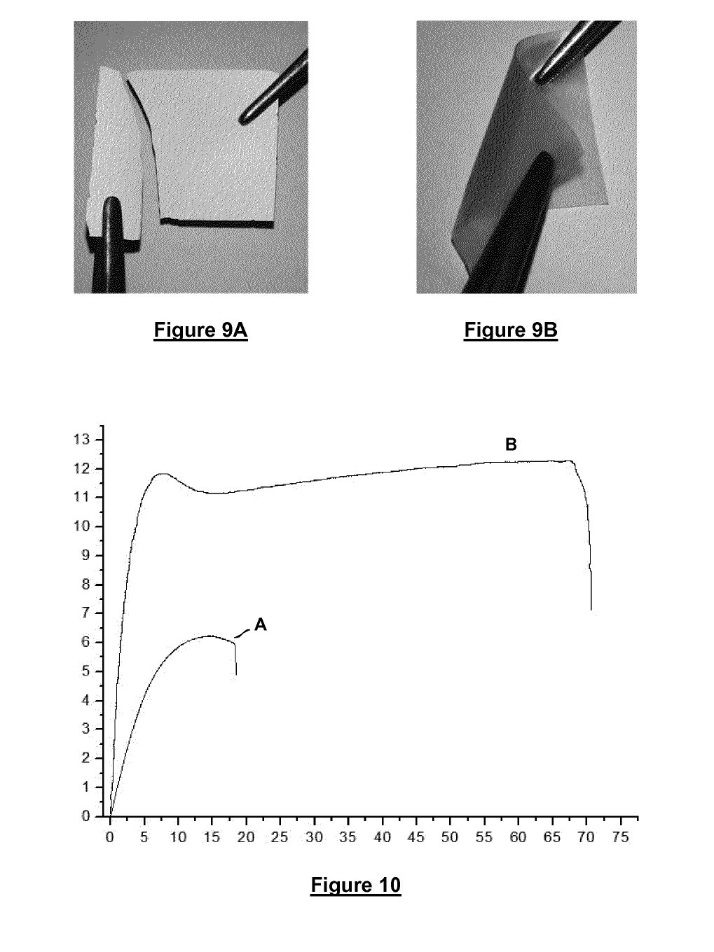

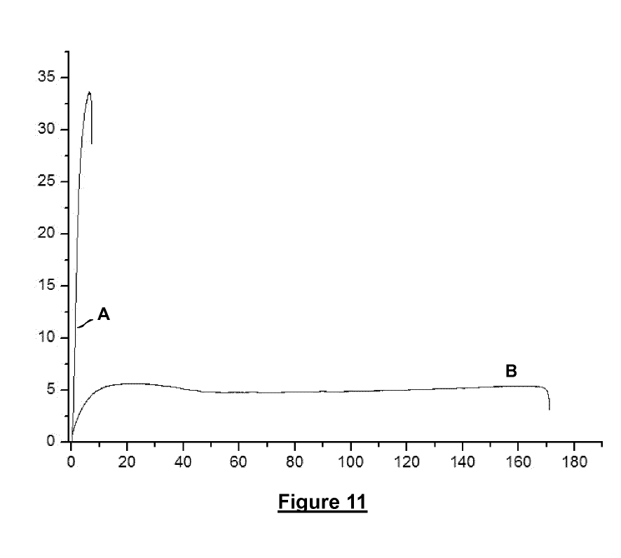

### EXAMPLES

### Example 1

### Preparation of a PHA/Sunflower Oil Material

The inventors prepared semi-interpenetrating networks comprising PHAs and crosslinked networks based on oil. The crosslinking of the oil was carried out by thiol-ene reaction. This reaction involves the addition of the thiol functions of trimethylolpropane tris(3-mercaptopropionate), a polyfunctional trithiol, to the double bonds of triglycerides. This thiol-ene reaction is initiated by a photoinitiator, 2,2-dimethoxy-2-phenylacetophenone (DMPA) under photochemical activation. The incorporation of oil in determined proportions (10 to 40% by weight relative to the polymer) is intended to confer novel properties on the PHAs.

1. Experimental Conditions

The inventors tested various PHAs: P3HB ([O—CH(CH₃)—CH₂—CO—]), P3HB88HV12 (obtained from Goodfellow; [-O—CH(CH₃)—CH₂—CO—] at 88%; [CH(CH₂CH₃)—CH₂—CO—] at 12%) and PHO (obtained from EMPA; [O—CH(C₅H₁₁)—CH₂—CO—]).

The experimental conditions for forming the semi-IPN network are collated in the following table:

First of all, PHBHV was precipitated in petroleum ether to extract the plasticizer, and PHB, sparingly soluble in the usual organic solvents (due to its high crystallinity), was heated to 60° C. in the dichloromethane solution for 5 min before adding the other reagents. The trithiol mass was calculated to have a ratio n_{SH/C═C}=1.

2. PHB and PHBHV Results

2.1. Mechanical Tests

Mechanical tests were carried out on standard test specimens, using a tensile testing machine (Instron, model 5965). The test specimens are pulled at a fixed speed of 2 mm/min. The principle of the tensile test is based on a uniaxial stress up to the breaking point of the test specimen in order to determine the mechanical characteristics thereof, such as Young's E modulus (rigidity of the material), the elongation at break, and the tensile strength. The results are reported in the following table and in FIGS. 3 and 4.

The incorporation of the oil into the polyester without crosslinking modifies the mechanical properties of the PHA. Indeed, the inventors observed a significant decrease in the Young's modulus (characteristic of the hardness of the material) going from 1011 to 516 MPa for the PHBHV and 954 to 739 MPa for the PHB. The oil impedes the crystallization of the polymer, resulting in a decrease in the modulus.

When the oil is crosslinked within the polymer, the inventors observed a more marked decrease in the Young's modulus (between 250 and 350 MPa for the PHBHV films and 250 MPa for the PHB films) but, on the other hand, a considerable increase in elongation at break is observed (up to 150% of its initial length). The material prepared therefore has elastic properties contrary to the initial polymer and this phenomenon is particularly marked.

The crosslinked oil (100%) forms a transparent gel, without hold and which is very tacky. When PHB (50%) is added, the film becomes easily detachable and non-tacky, and the latter strongly resembles rubber but with an absence of hold (the film tears easily) and the mechanical tests could not be realized.

2.2. Thermal Properties

The inventors studied the thermal properties of the PHB/oil films, with an oil load ranging from 50% to 100%, in order to discuss the influence of the oil in the co-network. Thermal degradation temperatures were evaluated by thermogravimetric analysis (TGA). The tests were carried out at 20° C./min over a temperature range extending from 20 to 800° C., under air. The shape of the thermograms obtained is characteristic of the structure and composition of the material.

The TGA results shown in FIG. 7 indicate that PHB degrades at close to 250° C. In the presence of oil, the degradation temperature is shifted towards high temperatures. The material only begins to decompose from 300° C. and gradually degrades up to 500° C. The first step of thermal degradation is attributed to the PHB and the second to the decomposition of the crosslinked oil. The incorporation of oil thus makes it possible to improve the thermal stability of the structure.

2. PHO Results

In this study, the inventors also investigated the formation of a semi-IPN network from a PHA with medium side chains (PHA-mcl).

The procedure is identical to that for the PHA-scls described above.

Conclusion

The combination of PHA-scls and crosslinked oil enabled the synthesis of a flexible material that had never been observed in the literature. According to the results obtained, the incorporation of 10% crosslinked oil was sufficient to improve the elastic properties of the material. This property makes it possible to envisage the competitiveness of this product with other polymers such as flexible PVC (flexible polyvinyl chloride), LDPE (low-density polyethylene) or PP (polypropylene). The comparison of the thermomechanical properties of these various polymers is presented in the table summarizing the thermal and mechanical properties of the usual polymers below.

The advantages of the synthesized material are its transparent color, its fruity odor and a high melting point (M.P.=165° C.) compared with that of PVC (M.P.<150° C.) or LDPE (M.P.=115° C.), which makes it possible to broaden its field of application. In addition, in contrast to LDPE and PVC, PHAs have better UV resistance.

It is also important to note that the mechanical properties of the pure polymers (without chemical modification) with which the inventors worked are not entirely similar to what has been described in the literature. Indeed, the Young's modulus of the PHBHV obtained by the inventors during their tests is less than the theoretical value (1100 MPa instead of 1500 MPa for a copolymer consisting of 12% HV units). The same applies to the PHB, for which they obtained a modulus of approximately 950 MPa instead of 3500 MPa. This difference may be due to the conditions under which they worked.

The following table summarizes the thermal and mechanical properties of the usual polymers, and also examples of materials according to the invention.

### Example 2

### Preparation of a PLA or PCL/Oil Material

The inventors also formed semi-IPN networks from polylactic acid or PLA or from polycaprolactone or PCL, working under the same operating conditions as those described for the PHAs in example 1.

The results are summarized in tables 1 and 2 and shown in FIGS. 5 and 6. A decrease in Young's modulus and in the tensile strength and an improvement in elongation at break are observed in both cases. These results coincide with those obtained with the PHAs. It is therefore possible to use this process using polymers other than PHAs.

This process may be applicable to other polymer families such as polyolefins (PE-HD, PP), rigid polyvinyl chlorides, styrenics (PS), polyacrylics (PMMA), polyamides, polycarbonates, saturated polyesters (PBT, PET, polyalkylene terephthalates), etc.

The following two tables respectively show the tensile results obtained on PCL/oil/trithiol and PLA/oil/trithiol films.

### Example 3

### Preparation of a Polyisoprene/Oil Material

The inventors also formed semi-IPN networks from PHA and polyisoprene, working under the same operating conditions as those described for example 1.

The results are shown in FIG. 8. A decrease in Young's modulus and tensile strength and an improvement in elongation at break (increase of 170% from its initial length) are observed. These results coincide with those obtained with the PHA/oil networks. It is therefore possible to use this process using polyunsaturated compounds other than oils.

### Example 4

### Preparation of a PHA/Oil Material by Extrusion

The extrusion was carried out using a HAAKE Minilab II Microcompounder machine. The equivalent of 7.5 cm³ of PHA/oil/photoactivator/trithiol mixture is inserted into the feed hopper. The temperature of the oven is set at 165° C. and the speed of rotation of the screws at 50 rpm. The injection of the material is then injected at 170° C. for 30 seconds before being recovered in a mold.

### Example 5

### Preparation of a PHA/Essential Oil (Linalool) Material

The inventors also formed semi-IPN networks from PHA and linalool (3,7-dimethyl-1,6-octadien-3-o1). Firstly, a homogeneous solution containing the following reagents:
linalool,
trithiol (n_{C═C}/n_{S—H}=1), and
DMPA (5 wt %),
   was prepared by dissolving the compounds at 50° C. for 2 min.

Subsequently, 0.3 g of PHB was mixed with 25% by weight of the above solution (which represents 10% by weight of linalool). Linalool makes it possible to dispense with the addition of CH₂Cl₂ to dissolve the PHB. The mixture was ground with a mortar to homogenize it. The mixture was heated to 150° C. for 2 min, then pressed at 1000 kg/ton ((SPECAC) mechanical press) for 2 min at 150° C. to obtain a film.

The inventors then irradiated the film under a UV lamp (Hamamatsu LC8 lamp (L8251) at a wavelength of 250 to 450 nm) for 300 seconds to obtain the semi-interpenetrating network. The films obtained are shown in FIGS. 9A and 9B. As shown in these photos, while the 100% PHB is very brittle, opaque and hard, the PHB/linalool/trithiol semi-IPN network is flexible, ductile and transparent. The mechanical tensile tests obtained on the PHB films and on the PHB/linalool films are indicated in the table below:

These data are shown in FIG. 10.

The formulation with the terpene (linalool) makes it possible to dispense with the use of a solvent during the preparation of the material. The material obtained has a more flexible character than PHB alone, or the PHB/linalool without irradiation, with an elongation at break which increases from 6 to 68% or from 18.4 to 68%.

### Example 6

### Preparation of a PHA/Modified Lignin Material

The inventors functionalized Kraft lignin by causing an allyl bromide to act on the alcohol functions in order to obtain a lignin containing unsaturations in accordance with the following reaction scheme:

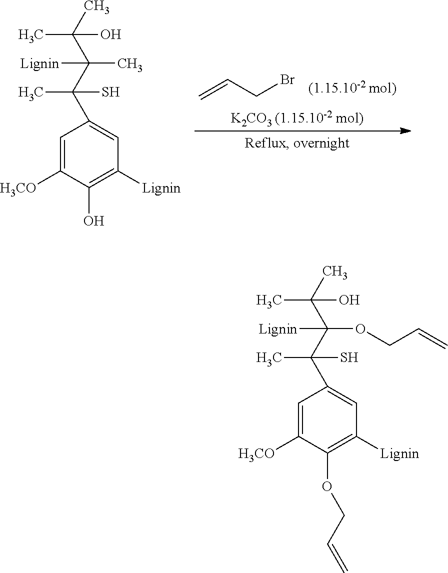

This unsaturated lignin was subsequently used as a reagent to form the semi-IPN network with trithiol, as in the previous examples.

The mechanical tensile tests obtained on the PHBHV films and on the PHB/linalool films are indicated in the table below:

These data are shown in FIG. 11.

The results obtained from the chemically modified lignin show that the semi-IPN network can be obtained from any molecule or polymer to which at least two unsaturations are added.

The invention is not limited to the embodiments presented and other embodiments will become clearly apparent to those skilled in the art.

1. A material comprising
a first crosslinked polymer forming a network, said first polymer being obtained by thiol-ene reaction between
a first composition comprising at least one first polyunsaturated carbon-based compound comprising at least one carbon-based chain comprising at least 5 carbon atoms, and
at least one second compound comprising at least two —SH functions, such that if the first polyunsaturated compound is bi-unsaturated, said second compound comprises at least three —SH functions, and if the first polyunsaturated compound is at least tri-unsaturated, said second compound comprises at least two —SH functions,
and
a second polymer consisting of n monomers, each of the monomers having the following formula I: 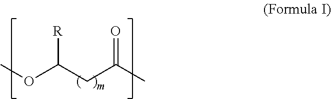
where m ranges from 0 to 4,
R is selected from hydrogen and an especially linear C1-C5 alkyl group, and
n is a non-zero natural integer greater than or equal to 100, or at least equal to 2,
the n monomers being identical or different
said material being such that it forms a semi-interpenetrating network in which the second polymer is entangled in the network of the first polymer.

2. The material according to claim 1, wherein said first at least one first polyunsaturated carbon-based compound comprising at least one carbon-based chain comprising at least 5 carbon atoms represents 40% or less by weight relative to the weight of said second polymer.

3. The material according to claim 1, wherein said first compound is an at least bi-unsaturated triglyceride, or a polyisoprene, essential fatty acids, or terpenes, especially carotene, farnesene, lycopene, phytoene, linalool or geraniol.

4. The material according to claim 1, wherein said first composition comprises at least one first polyunsaturated carbon-based compound comprising at least one unsaturated carbon-based chain is a composition comprising or consisting of one or more oils selected from vegetable oils, fish oils, and microbial oils resulting from microorganisms referred to as oleaginous.

5. The material according to claim 1, wherein the second polymer is a polyhydroxyalkanoate polymer with short side chains, or PHA-scl, consisting of n monomers of formula I, where m ranges from 1 to 3,
R is selected from hydrogen, an ethyl group and a methyl group, and
n is a non-zero natural integer greater than or equal to 100.

6. The material according to claim 1, wherein the compound comprising at least two —SH functions is selected from the following compounds: trimethylolpropane tris(3-mercaptopropionate), pentaerythritol tetrakis (3 -merc aptopropionate), pentaerythritol tetrakis(3 -merc aptobu tyrate), glycol dimercaptoacetate and tris[2-(3-mercaptopropionyloxy)ethyl]isocyanurate.

7. A process for preparing a material, said process comprising
a) mixing:
a first composition comprising at least one first polyunsaturated carbon-based compound comprising at least one unsaturated carbon-based chain, with
at least one compound comprising at least two —SH functions,
at least one radical initiator,
and at least one polymer consisting of n monomers, each of the monomers having the following formula I: 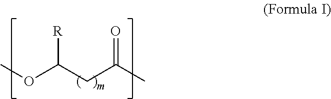
where m ranges from 0 to 4,
R is selected from hydrogen, an ethyl group and an especially linear C1-C5 alkyl group, and
n is a non-zero natural integer greater than or equal to 100, or at least equal to 2,
the n monomers being identical or different,
to obtain an initial composition,
and
b) crosslinking the first polymer between said at least one polyunsaturated carbon-based comprising at least one unsaturated carbon-based chain and the compound comprising at least two —SH functions
wherein the material comprises:
a first crosslinked polymer forming a network, said first polymer being obtained by thiol-ene reaction between
a first composition comprising at least one first polyunsaturated carbon-based compound comprising at least one carbon-based chain comprising at least 5 carbon atoms, and
at least one second compound comprising at least two —SH functions, such that if the first polyunsaturated compound is bi-unsaturated, said second compound comprises at least three —SH functions, and if the first polyunsaturated compound is at least tri-unsaturated, said second compound comprises at least two —SH functions, and
a second polymer consisting of n monomers, each of the monomers having the following formula I: 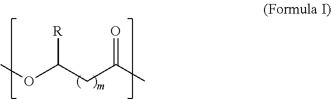
where m ranges from 0 to 4,
R is selected from hydrogen and an especially linear C1-C5 alkyl group, and
n is a non-zero natural integer greater than or equal to 100, or at least equal to 2,
the n monomers being identical or different,
said material being such that it forms a semi-interpenetrating network in which the second polymer is entangled in the network of the first polymer.

8. The process according to claim 7, wherein the radical initiator is a photochemical radical initiator, especially selected from camphorquinone, ethyl 4-dimethylaminobenzoate, and 2,2-dimethoxy-2-phenylacetophenone.

9. The process according to claim 7, wherein said composition comprising at least one first polyunsaturated carbon-based compound comprising at least one unsaturated carbon-based chain is a composition comprising or consisting of one or more oils selected from vegetable oils, fish oils, and microbial oils resulting from microorganisms referred to as oleaginous.

10. The process according to claim 7, wherein the first composition comprising said first compound represents 40% or less by weight relative to the weight of said polymer consisting of n monomers of formula I.

11. The process according to claim 7, wherein the second polymer is a polyhydroxyalkanoate polymer with short side chains, or PHA-scl, of formula I, where m ranges from 1 to 3,
R is selected from hydrogen, an ethyl group and a methyl group, and
n is a non-zero natural integer greater than or equal to 100.

12. The process according to claim 7 , wherein the mixing step consists of, for 15 to 30 minutes in a suitable receptacle, bringing a composition comprising rapeseed oil and/or sunflower oil into contact with
Trimethylolpropane tris(3-merc aptopropionate),
poly(3-hydroxybutyrate) and/or poly(3-hydroxybutyrate-co-3-hydroxyvalerate), and
2,2-dimethoxy-2-phenylacetophenone, and
a solvent
to form the initial composition.

13. (canceled)

14. A material comprising
a first crosslinked polymer forming a network, said first polymer being obtained by thiol-ene reaction between
a first composition comprising at least one first polyunsaturated carbon-based compound comprising at least one carbon-based chain comprising at least 5 carbon atoms, and
at least one second compound comprising at least two —SH functions, such that if the first polyunsaturated compound is bi-unsaturated, said second compound comprises at least three —SH functions, and if the first polyunsaturated compound is at least tri-unsaturated, said second compound comprises at least two —SH functions, and
a second polymer consisting of n monomers, each of the monomers having the following formula I: 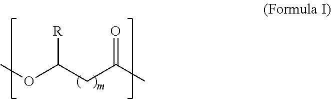
where m ranges from 0 to 4,
R is selected from hydrogen and an especially linear C1-C5 alkyl group, and
n is a non-zero natural integer greater than or equal to 100, or at least equal to 2,
the n monomers being identical or different, said material being such that it forms a semi-interpenetrating network in which the second polymer is entangled in the network of the first polymer,
wherein the material is used for the preparation of biodegradable and/or compostable food containers, packaging, coatings, for the preparation of injected parts or parts manufactured by extrusion or for the preparation of surface coatings.

15. The material of claim 14, wherein the material is used in human or animal surgery.

16. The material according to claim 4, wherein the vegetable oil is rapeseed oil, oleic rapeseed oil, sunflower oil, or a combination of rapeseed oil and sunflower oil.

17. The material according to claim 5, wherein said PHA-scls is poly-3-hydroxybutyrates or PHBs and/or poly(3-hydroxybutyrate-co-3-hydroxyvalerate)s or PHBHVs.

18. The process according to claim 11, wherein said PHA-scls is poly-3-hydroxybutyrates or PHBs and/or poly(3-hydroxybutyrate-co-3-hydroxyvalerate)s or PHBHVs.

19. The material of claim 14, wherein the coatings are surface coatings.

20. The material of claim 14, wherein the material is used for the manufacture of interior coatings for vehicles or else for the preparation of textiles or ropes
